(19) United States
(12) Patent Application Publication
(10) Pub. No.: US 2026/0237883 A1
(43) Pub. Date: Aug. 13, 2026

(54) ELECTRONIC DEVICE

(71) Applicant: VIVO MOBILE COMMUNICATION CO., LTD., Guangdong (CN)

(72) Inventors: Bo SONG, Guangdong (CN); Yue SHI, Guangdong (CN); Yanhui TAO, Guangdong (CN); Yuhao FU, Guangdong (CN)

(21) Appl. No.: 19/467,021

(22) Filed: Feb. 2, 2026

Related U.S. Application Data
(63) Continuation of application No. PCT/CN2024/108023, filed on Jul. 29, 2024.

(30) Foreign Application Priority Data
Aug. 3, 2023 (CN) 202310970516.8

(51) Int. Cl. H01Q 1/22; H01Q 5/30; H01Q 9/30

(52) U.S. Cl. CPC H01Q 1/22; H01Q 5/30; H01Q 9/30

(57) ABSTRACT

This application discloses an electronic device. The electronic device includes a first radiator, a metal battery compartment, and a connecting member. The first radiator includes a first end and a second end, and a feed point of the first radiator is located between the first end and the second end. The metal battery compartment includes a first sidewall and a backplane, the first sidewall is disposed on a periphery of the backplane, and the backplane is grounded. The first radiator is located outside the metal battery compartment, and there is a first gap between the first radiator and the first sidewall. The connecting member is located in the first gap, and is connected to a first position of the first sidewall and a second position of the first radiator. The second position is located between the first end of the first radiator and the feed point.

### CROSS-REFERENCE TO RELATED APPLICATIONS

This application is a continuation application of PCT International Application No. PCT/CN2024/108023 filed on July 29, 2024, which claims priority to Chinese Patent Application No. 202310970516.8, filed in China on August 3, 2023, which are incorporated herein by reference in their entireties.

### TECHNICAL FIELD

This application pertains to the field of communication technologies, and specifically, relates to an electronic device.

### BACKGROUND

With continuous improvement of people's quality of life and continuous enrichment of content of life, people have an increasingly high requirement for communication quality in various scenarios of life, for example, quality of making a call and quality of accessing Internet under weak signal conditions (in scenarios such as an elevator, an underground parking garage, an open country, high-speed rail and subway, and corners of a bedroom and a bathroom). In this case, a scenario performance requirement for various communication functions of a mobile terminal is increasingly high, and a scenario adaptability to an antenna function is also increasingly high.

In a related technology, an antenna scenario adaptation design requires an addition of a component or an electronic component, and an addition of development of a software algorithm. In these manners, production costs of an electronic device are increased.

### SUMMARY

According to a first aspect, an embodiment of this application provides an electronic device, including a first radiator, a metal battery compartment, and a connecting member, where

the first radiator includes a first end and a second end, and a feed point of the first radiator is located between the first end and the second end;

the metal battery compartment includes a first sidewall and a backplane, the first sidewall is disposed on a periphery of the backplane, and the backplane is grounded;

the first radiator is located outside the metal battery compartment, and there is a first gap between the first radiator and the first sidewall;

the connecting member is located in the first gap, and is connected to a first position of the first sidewall and a second position of the first radiator; and the second position is located between the first end of the first radiator and the feed point; and

a first through hole is provided on the first sidewall, the first through hole extends in a length direction of the first radiator, and the first through hole is provided between the first position and the backplane; or a distributed inductor is formed between the connecting member and the first sidewall.

### BRIEF DESCRIPTION OF DRAWINGS

FIG. 1 is a top view of a first electronic device according to an embodiment of this application;

FIG. 2 is a side view of a first electronic device according to an embodiment of this application;

FIG. 3 is a schematic diagram of an operating frequency band of an antenna module in a first electronic device according to an embodiment of this application;

FIG. 4 is a curve diagram of radiation efficiency of an antenna module in an electronic device according to an embodiment of this application and an antenna module in a related technology;

FIG. 5 is a curve diagram of total efficiency of an antenna module in an electronic device according to an embodiment of this application and an antenna module in a related technology;

FIG. 6 is a side view of a second electronic device according to an embodiment of this application;

FIG. 7 is a schematic diagram of an operating frequency band of a second electronic device according to an embodiment of this application;

FIG. 8 is a side view of a third electronic device according to an embodiment of this application;

FIG. 9 is a schematic diagram of a circuit structure of a first switching module according to an embodiment of this application;

FIG. 10 is a schematic diagram of an operating frequency band of an antenna module in a third electronic device according to an embodiment of this application;

FIG. 11 is a side view of a fourth electronic device according to an embodiment of this application;

FIG. 12 is a side view of a fifth electronic device according to an embodiment of this application;

FIG. 13 is a top view of a sixth electronic device according to an embodiment of this application;

FIG. 14 is a top view of a seventh electronic device according to an embodiment of this application; and

FIG. 15 is a schematic diagram of a circuit structure of a second switching module according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

In the specification and claims of this application, the terms such as "first" and "second" are intended to distinguish between similar objects instead of describing a specified order or sequence. It should be understood that, data used in this way may be interchangeable under appropriate circumstances, so that the embodiments of this application can be implemented in an order other than that illustrated or described herein. Moreover, the terms such as "first", "second", and the like typically distinguish between objects of one category rather than limiting a quantity of objects. For example, there may be one or more first objects. In addition, in the specification and claims, "and/or" represents at least one of connected objects, and the character "/" usually represents an "or" relationship between associated objects.

In a related technology, a metal frame of an electronic device may be used to form an antenna radiator. The electronic device in embodiments of this application may be any electronic device with an antenna, such as a mobile phone, a tablet computer, a base station, a watch, or a notebook. For ease of description, in the embodiments of this application, that the electronic device is a mobile phone is used as an example for description and constitutes no specific limitation herein.

The electronic device such as a mobile phone may have a plurality of handheld scenarios, such as a portrait scenario and a landscape scenario. In different handheld scenarios, a hand of a user blocks a part of an antenna on the electronic device, affecting antenna performance.

In the related technology, the following manner may be used to overcome a problem that antenna performance of a communication device degrades due to human body blocking when the user holds the communication device by hand.

(1) Antennas operating in various standards need to adapt to various scenarios, for example, long term evolution (LTE), new radio (NR), wireless fidelity (Wi-Fi), and global positioning system (GPS). However, a scenario adaptation design proposed in this solution is usually concentrated in a high frequency part.

(2) In a low frequency band, it is often impossible to make many changes due to a size limitation of a mobile terminal. In this case, a scenario adaptability problem in the low frequency band is more prominent. Currently, a switch is usually added to combine with a software algorithm to switch different antennas, or an additional component is added. This is also a common method in a medium-high band.

However, the foregoing manner has at least the following defects: First, an antenna scenario adaptation design in the related technology is more concentrated at a high frequency band. Second, in the related technology, the antenna scenario adaptation design requires an addition of a component or an electronic component (for example, an antenna switch), and an addition of development of the software algorithm, which often requires a significant increase in costs.

In the embodiments of this application, via a connecting member, a first sidewall on a metal battery compartment is connected to a first radiator, and a backplane of the metal battery compartment is grounded. A first through hole extending in a length direction of the first radiator may be provided on the first sidewall, to form a grounding structure of a distributed inductor. Alternatively, the distributed inductor is formed through the connecting member connected between the first sidewall and the first radiator and the first sidewall. In this way, the grounding structure of the distributed inductor is used to enable an excitation current on the first radiator to be grounded through the grounding structure of the distributed inductor, so that energy in a first region on the first radiator can be transferred to a second region. The first region is a region between the first end and a first position, and the second region is a region between the first end and a second position. Therefore, some energy of an antenna module can be transferred to a handheld region in a landscape game scenario away from the electronic device, reducing an impact of handholding, and improving antenna performance in this scenario.

In addition, in comparison with the related technology, in this embodiment of this application, no electronic component needs to be added, and no software algorithm needs to be matched, so that structure complexity and production costs of the antenna module can be reduced while scenario adaptability of the antenna is improved.

It should be noted that the antenna module in the electronic device provided in the embodiments of this application may be a low-frequency operating module, or may be a medium-high-frequency antenna module. For ease of description, in the embodiments of this application, that the antenna module is a low-frequency operating module is usually used as an example for description and constitutes no specific limitation herein.

The electronic device provided in the embodiments of this application is described below in detail with reference to the accompanying drawings through specific embodiments and application scenarios thereof.

### Embodiment 1

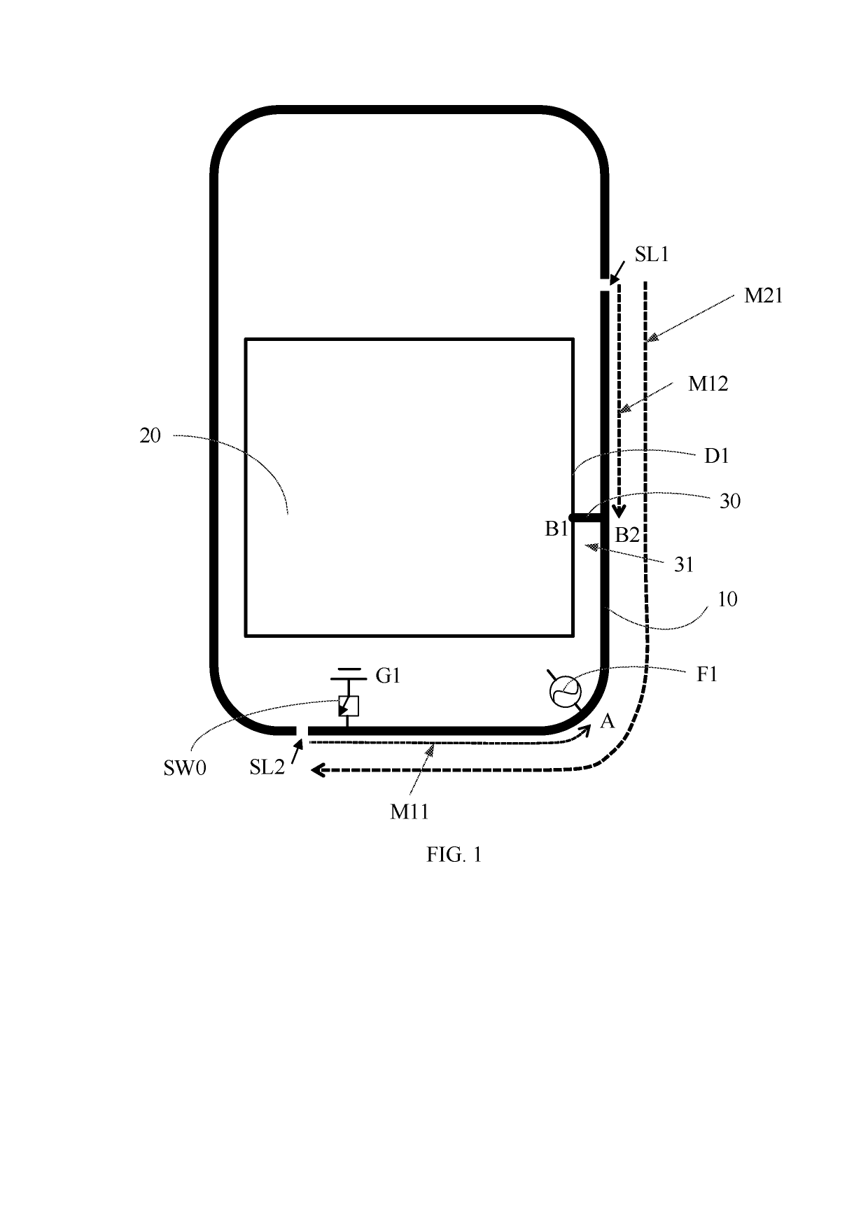

Referring to FIG. 1, this embodiment of this application provides an electronic device, including a first radiator 10, a metal battery compartment 20, and a connecting member 30.

The first radiator 10 includes a first end and a second end, and a feed point A of the first radiator 10 is located between the first end and the second end.

The metal battery compartment 20 includes a first sidewall D1 and a backplane G1, the first sidewall D1 is disposed on a periphery of the backplane G1, and the backplane G1 is grounded.

The first radiator 10 is located outside the metal battery compartment 20, and there is a first gap 31 between the first radiator 10 and the first sidewall D1.

The connecting member 30 is located in the first gap 31, and is connected to a first position B1 of the first sidewall D1 and a second position B2 of the first radiator 10, and the second position B2 is located between the first end of the first radiator 10 and the feed point A.

A first through hole S1 is provided on the first sidewall D1, the first through hole S1 extends in a length direction of the first radiator 10, and the first through hole S1 is provided between the first position B1 and the backplane G1; or a distributed inductor is formed between the connecting member 30 and the first sidewall D1.

During operation, a feed F1 provides an excitation current to the first radiator 10 via the feed point A, and at least a part of the excitation current is grounded via the connecting member 30 and the distributed inductor. This enables the connecting member 30 to transfer at least a part of an excitation current in a first region on the first radiator 10 to a second region on the first radiator 10. The first region is a region between the first end and the feed point A, and the second region is a region between the first end and the second position B2.

In some implementations, the first end of the first radiator 10 may be an end portion of the first radiator 10 facing a second slit SL1 as shown in FIG. 1, and the second end of the first radiator 10 may be an end portion of the first radiator 10 that faces a third slit SL2 as shown in FIG. 1.

Optionally, the first end is located on a first long edge of the electronic device, the second end is located on a first short edge of the electronic device, and the first long edge is adjacent to the first short edge.

The feed point A may be located in a corner region between the first long edge and the first short edge, and the corner region is located in a landscape handheld region of the electronic device. In other words, radiation energy in the first region may be blocked by a hand of a user. If energy is radiated via the first region, antenna performance is affected.

Optionally, the first radiator 10 is divided into a first sub-radiator and a second sub-radiator via the feed point A as a boundary, and the first sub-radiator and the second sub-radiator are respectively disposed on adjacent edges of a metal frame. For example, the first sub-radiator is a radiator between the feed point A and the second slit SL1, and the second sub-radiator is a radiator between the feed point A and the third slit SL2. In this case, it is assumed that the first sub-radiator is located on a long edge of the metal frame, and the second sub-radiator is located on a short edge of the metal frame.

In this case, a region between the feed point A and the second position B2 may be located in a landscape handheld region of the electronic device, and the landscape handheld region indicates a region held or blocked by a finger of the user when the electronic device is in a landscape application scenario.

Optionally, the second position B2 is located in a target region on the first long edge, and the target region is located outside the landscape handheld region of the electronic device.

In this implementation, the second position B2 is disposed outside the landscape handheld region of the electronic device. When radiation energy in the first region is transferred to the second region, the second region is also located outside the landscape handheld region of the electronic device.

In some implementations, to set the second position B2 in the target region, a distance between the second position B2 and the first short edge may be greater than or equal to a 1/6 or a 1/5 of a length of the first long edge, or the like.

Optionally, a length of the first sub-radiator may be greater than or equal to half of the long edge of the metal frame, and a length of the second sub-radiator may be greater than or equal to half of the short edge of the metal frame.

When the length of the first sub-radiator is greater than or equal to half of the long edge of the metal frame, a region on the first sub-radiator close to the first end is obviously located outside the landscape handheld region of the electronic device.

Optionally, an end portion of the second sub-radiator close to the third slit SL2 may be grounded via a tuning module SW0, and the tuning module SW0 may implement frequency tuning on the antenna.

Certainly, for different types or structures of antenna radiators, it is not necessary to provide slits at two ends of the antenna radiator. For example, an end portion of the antenna radiator is connected to another metal structure, and is grounded via a feed ground structure and the like. In addition, the radiator may alternatively be disposed in another region of the metal frame, or may be disposed in a position even outside the metal frame. For ease of description, in this embodiment of this application, that the first radiator 10 is disposed on the metal frame, and two ends of the first radiator 10 are respectively provided with the second slit SL1 and the third slit SL2 is used as an example for description, and does not constitute a specific limitation on a structure of the first radiator 10 herein.

In this implementation, the first region on the first radiator 10 may be a region between the second slit SL1 and the feed point A, and the second region on the first radiator 10 may be a region between the second slit SL1 and the second position B2. In other words, an energy transfer path may be from the feed point A to the second position B2, and grounding is implemented via the connecting member 30 and the distributed inductor.

In some implementations, a position of the second position B2 may be adjusted based on a handheld region of the user in different application scenarios, that is, a distance between the feed point A and the second position B2 is adjustable.

For example, as shown in FIG. 1, in a landscape scenario, a lower right corner of the metal frame shown in FIG. 1 is usually blocked by a hand of the user, and the region between the feed point A and the second position B2 is located in a blocked region in the landscape scenario. Based on this, the position of the second position B2 may be adjusted, to shift energy between the feed point A and the second position B2 outside the blocked region.

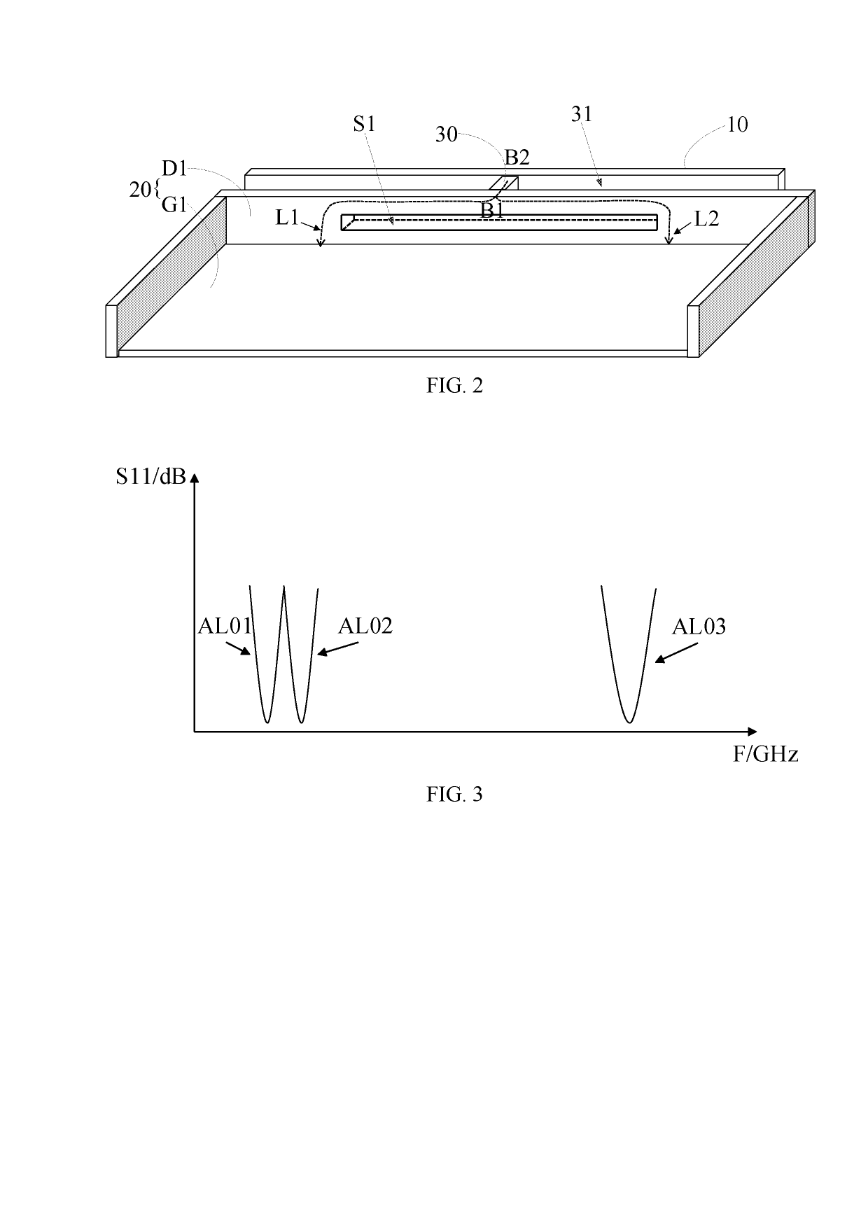

In some implementations, the metal battery compartment 20 is disposed on the electronic device such as a mobile phone, and the metal battery compartment 20 is configured to accommodate a battery. The first radiator 10 may be disposed outside the metal battery compartment 20, and spaced apart from the first sidewall D1 of the metal battery compartment 20. To be specific, the first sidewall D1 may be a sidewall that is on the metal battery compartment 20 and that is parallel to the second region (namely, the region between the second slit SL1 and the second position B2) on the first radiator 10 and is closest to the first radiator 10. In addition, as shown in FIG. 2, the backplane of the metal battery compartment 20 may be grounded, so that the backplane of the metal battery compartment 20 may be considered as main ground, that is, a bottom of the first sidewall D1 is connected to the main ground. In this way, the second position B2 on the first radiator 10 may be connected to the main ground via the connecting member 30 and the first sidewall D1.

For example, as shown in FIG. 1, the first radiator 10 is disposed on the metal frame, and the metal frame surrounds the metal battery compartment 20 and has a gap with a periphery of the metal battery compartment 20. In this case, the connecting member 30 may be disposed in the first gap 31 between the first radiator 10 and a sidewall on the metal battery compartment 20 close to the first radiator 10, so that an excitation current of the second position B2 of the first radiator 10 is grounded via the connecting member 30 and the metal battery compartment, thereby shifting energy between the second position B2 and the feed point A to the region between the second position B2 and the second slit SL1.

It should be noted that, in an implementation, the antenna module in the electronic device shown in FIG. 1 has the following three operation modes in an operating frequency band:

a monopole mode M11 on a bottom, that is, a monopole mode excited on the second sub-radiator;

an inverted-F antenna (IFA) mode M12 on an edge, that is, an IFA mode excited on the first sub-radiator; and

a half-wavelength mode M21 on the entire first radiator 10.

A mode for implementing energy transfer may be the IFA mode M12 on the edge, that is, in the M12 mode, energy located in the first region is transferred to the second region.

It should be noted that, in a related technology, if the connecting member 30 is not disposed to be connected to the metal battery compartment 20, in the IFA mode on the edge, energy on the first radiator 10 is distributed between the feed point A and the second slit SL1. In this embodiment of this application, in the IFA mode on the edge, the energy on the first radiator 10 is distributed between the second position B2 and the second slit SL1, thereby implementing transfer of some energy, which helps flexibly adjust a distribution interval of antenna radiation energy on the first radiator 10. In this way, when the electronic device is applied to a specific scenario, radiation energy on the first radiator 10 can be transferred, based on a handheld region of the user in the scenario, to a region not blocked by the hand of the user, to improve antenna performance in the scenario.

In some implementations, considering that if the second position B2 is directly grounded via the connecting member 3, a problem that it is difficult to excite the IFA mode M12 may occur. In this case, a grounding structure of the distributed inductor may be disposed at a strong current point of the IFA mode M12. In this case, grounding of the distributed inductor also enables energy in a wide frequency band to excite the IFA mode M12 in the second region between the second slit SL1 and the second position B2 via a grounding point. In addition, due to introduction of the distributed inductor, there is better impedance matching in the wide frequency band. Therefore, in the operating frequency band, a characteristic of a traveling wave transmission is formed between the feed point A and the second position B2, so that energy in the IFA mode M12 on the edge can be transferred from the first region to the second region more effectively.

In an optional implementation, that a length direction of the first through hole S1 is parallel to the first radiator 10 may be understood as: The length direction of the first through hole S1 is parallel to a part of the first radiator 10 that is located in the second region.

That the first through hole S1 is provided between the first position B1 and the backplane G1 may be understood as: The first position B1 and the backplane G1 are distributed on two sides of the first through hole S1. For example, as shown in FIG. 2, the first through hole S1 extending laterally is provided on the first sidewall D1, the first position B1 is located on an upper side of the first through hole S1, and the backplane G1 is located on a lower side of the first through hole S1.

In this implementation, a structure of the distributed inductor may be formed through the first through hole S1. For example, as shown in FIG. 2, based on the first through hole S1, a current at the second position B2 on the first radiator 10 may be grounded via a path L1 of the distributed inductor and a path L2 of the distributed inductor, that is, antenna energy flows back to the backplane G1 (namely, the main ground) through the two paths L1 and L2 via the connecting member 30.

Optionally, a length of the first through hole S1 is less than or equal to a 1/2 wavelength of a first operating frequency band of an antenna module corresponding to the first radiator 10.

In a case that the antenna module is a low frequency antenna, the first operating frequency band of the antenna module may be a low frequency band. In this case, the length of the first through hole S1 may be between 30–60 mm.

In this implementation, the length of the first through hole S1 is controlled within a 1/2 wavelength of the first operating frequency band of the antenna module, so that resonance interference generated by the first through hole S1 can be reduced.

It should be noted that, in some implementations, the length of the first through hole S1 may be further adjusted to excite a high-frequency slot mode (for example, N41/N78/N79) in a slot structure of the first through hole S1, to further increase the operating frequency band of the antenna module.

Optionally, a length of a region in the first radiator that is located between the feed point A and the second position B2 is less than or equal to a 1/2 wavelength of the first operating frequency band, and the first operating frequency band is an operating frequency band of the antenna module corresponding to the first radiator 10.

In a case that the antenna module is a low frequency antenna, the operating frequency band of the antenna module may be a low frequency band. To be specific, a length of the region between the feed point A and the second position B2 is less than or equal to a 1/2 wavelength of the operating frequency band of the antenna module.

It should be noted that, in a case that the length of the region between the feed point A and the second position B2 exceeds a 1/2 wavelength of the first operating frequency band of the antenna module, an additional influence mode may be introduced. In this case, interference is generated to an existing mode of the antenna module, for example, the monopole mode M11 on the bottom, the IFA mode M12 on the edge, and the half-wavelength mode M21 on the entire first radiator 10.

The first operating frequency band may be an operating frequency band corresponding to the monopole mode M11 on the bottom of the first radiator 10, the IFA mode M12 on the edge, and the half-wavelength mode M21 on the entire first radiator 10, for example, a low-frequency operating frequency band.

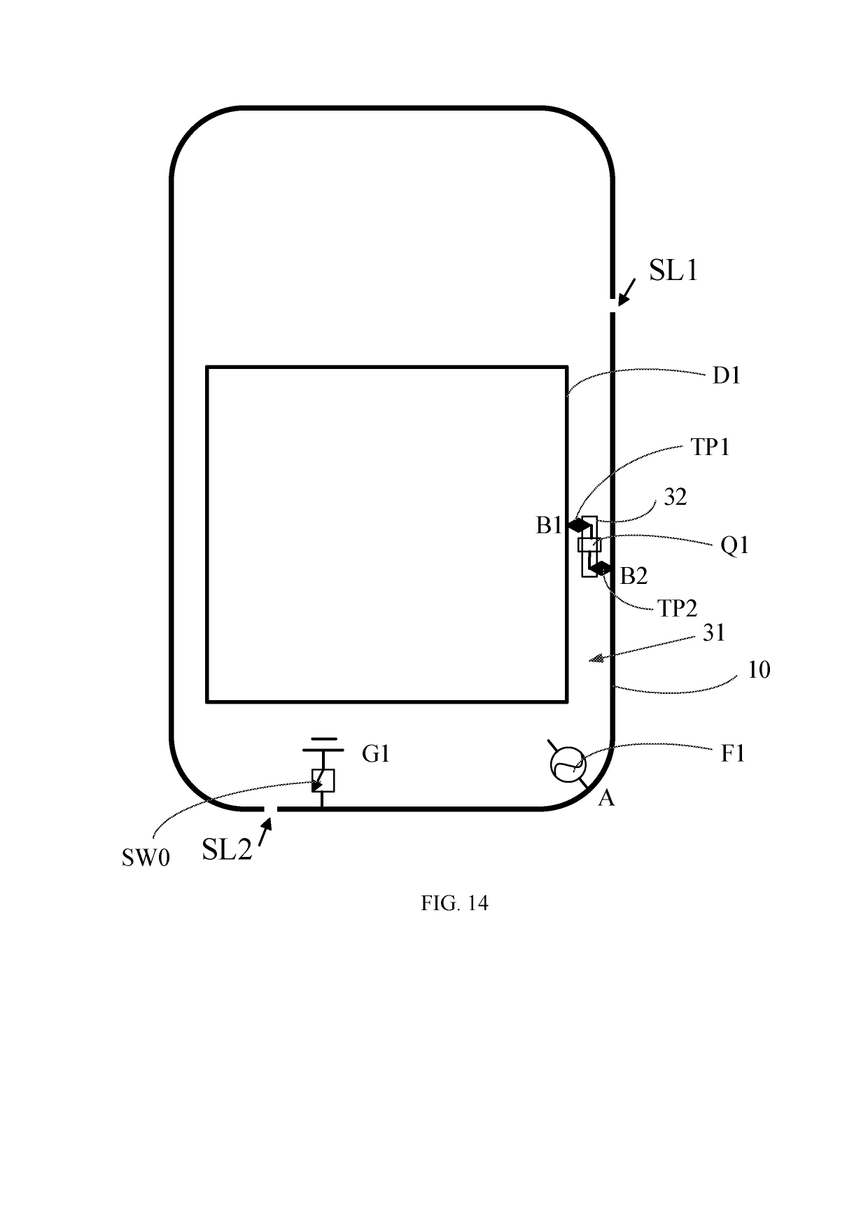

In another optional implementation, the connecting member 30 may be further used to form a structure of a distributed inductor or an inductor may be connected in series to the connecting member 30. For example, as shown in FIG. 11, the connecting member 30 includes a third connection portion PL1 that is parallel to and spaced apart from the first sidewall D1. In this way, the distributed inductor may be formed through the PL1 and the first sidewall D1. Alternatively, as shown in FIG. 14, a second switching module Q1 may be connected in series to the connecting member 30, to adjust at least one of a grounding capacitance, a resistance, or an inductance of the second position B2.

It should be noted that, compared with the foregoing manner in which the connecting member 30 is used to form the structure of the distributed inductor or the inductor is connected in series to the connecting member 30, in a manner in which the first through hole S1 is provided on the first sidewall D1 to implement grounding of the distributed inductor, it is not necessary to increase the gap between the metal battery compartment 20 and the metal frame, to dispose the connecting member 30 in a relatively complex structure, thus avoiding a need to occupy space in the metal battery compartment 20 and not reducing battery capacity.

Certainly, the first through hole S1 may be provided on the first sidewall D1 to implement grounding of the distributed inductor, and a structure of the connecting member 30 shown in FIG. 11 is further disposed. This is not specifically limited herein.

Corresponding to the electronic devices shown in FIG. 1 and FIG. 2, the first radiator 10 of the antenna module in the electronic device is disposed on a metal frame of the mobile phone. In this case, some energy on the antenna radiator can be transferred via the antenna module in the electronic device in this embodiment of this application, to improve antenna performance of the electronic device in various scenarios.

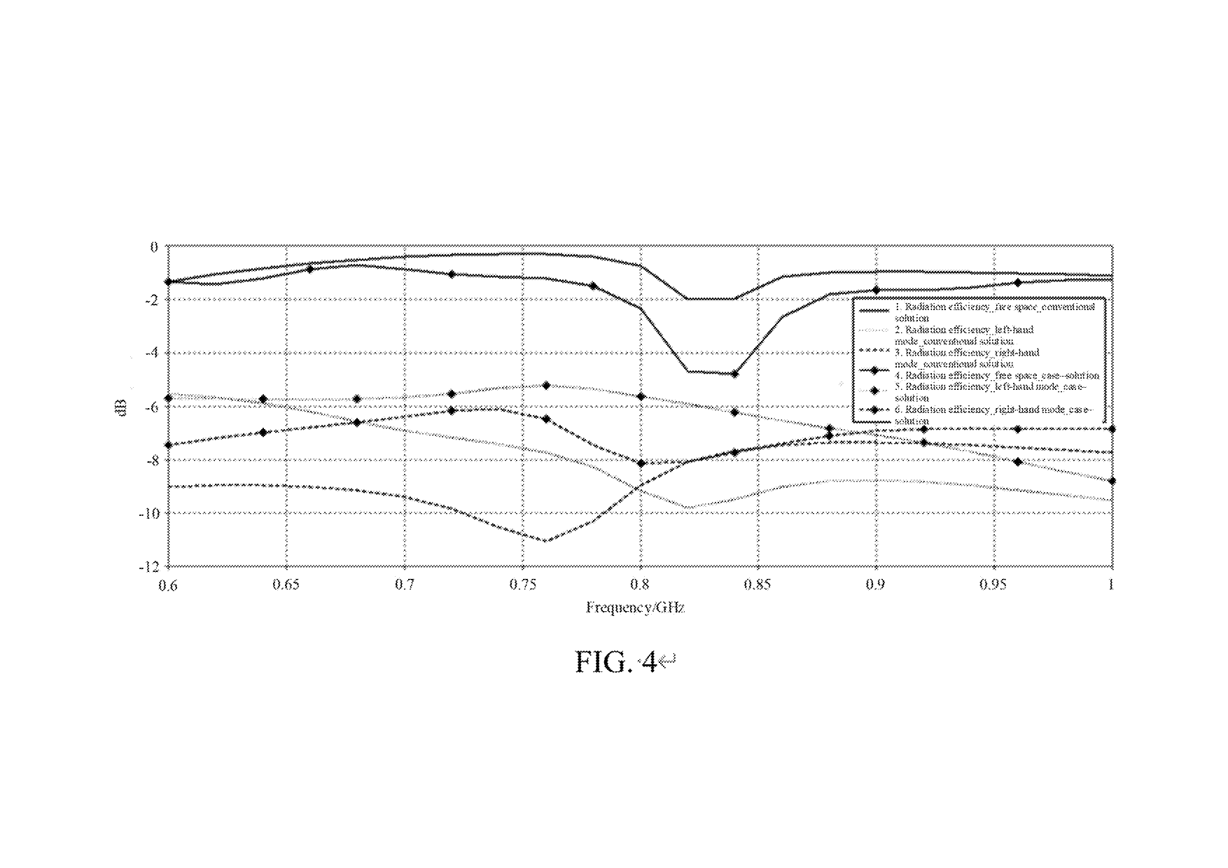

Specifically, assuming that both the antenna module in the electronic device shown in FIG. 1 and FIG. 2 and the antenna module in the related technology operate in a band N28 (approximately 0.705–0.805 GHz), as shown in FIG. 4, compared with an antenna module without energy transfer, the antenna module in the electronic device shown in FIG. 1 and FIG. 2 has significant improvement in radiation efficiency of the antenna module in various scenarios such as a scenario in which the mobile phone is held in the left hand and a scenario in which the mobile phone is held in the right hand.

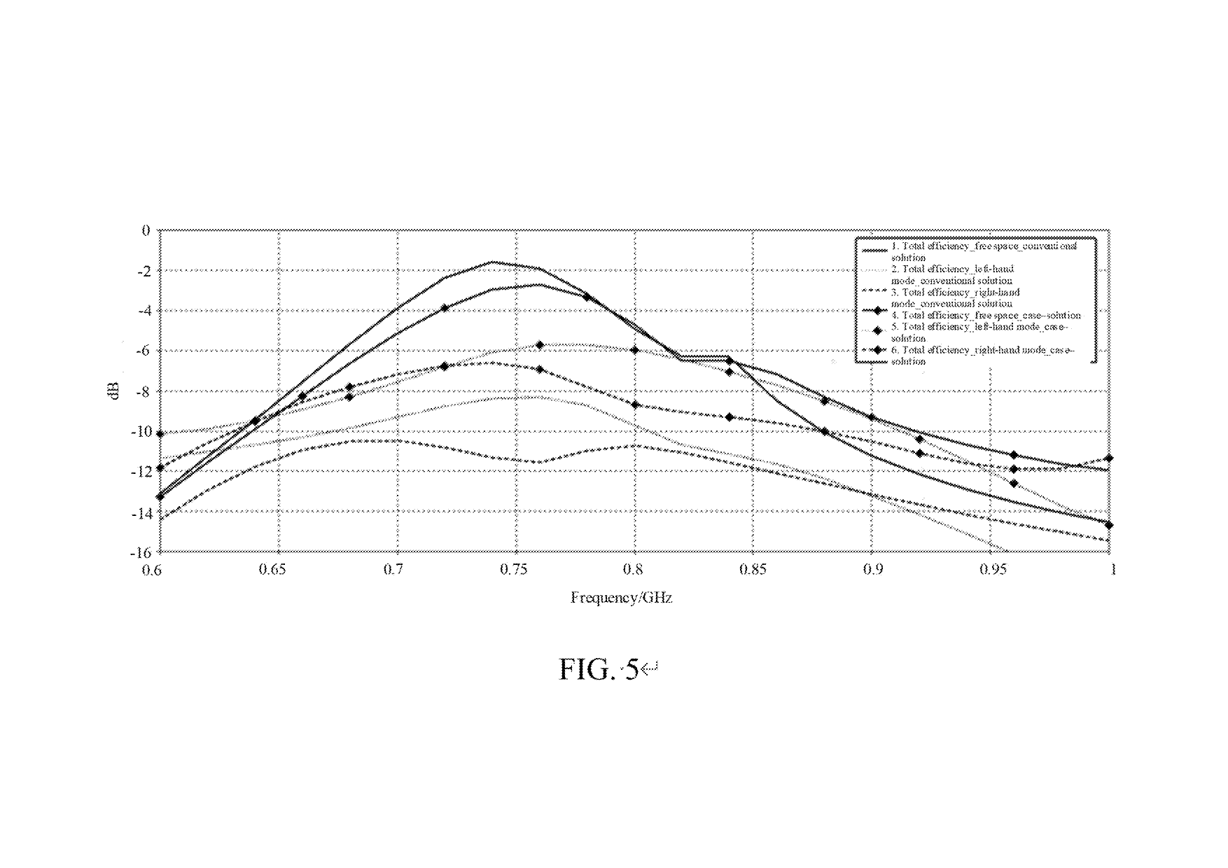

In addition, as shown in FIG. 5, by comparing the total low-frequency efficiency in a free space state with that in a left/right-hand mode state, it may be learned that the antenna module shown in FIG. 1 and FIG. 2 is also significantly better than the antenna module in the related technology in terms of the total efficiency.

### Embodiment 2

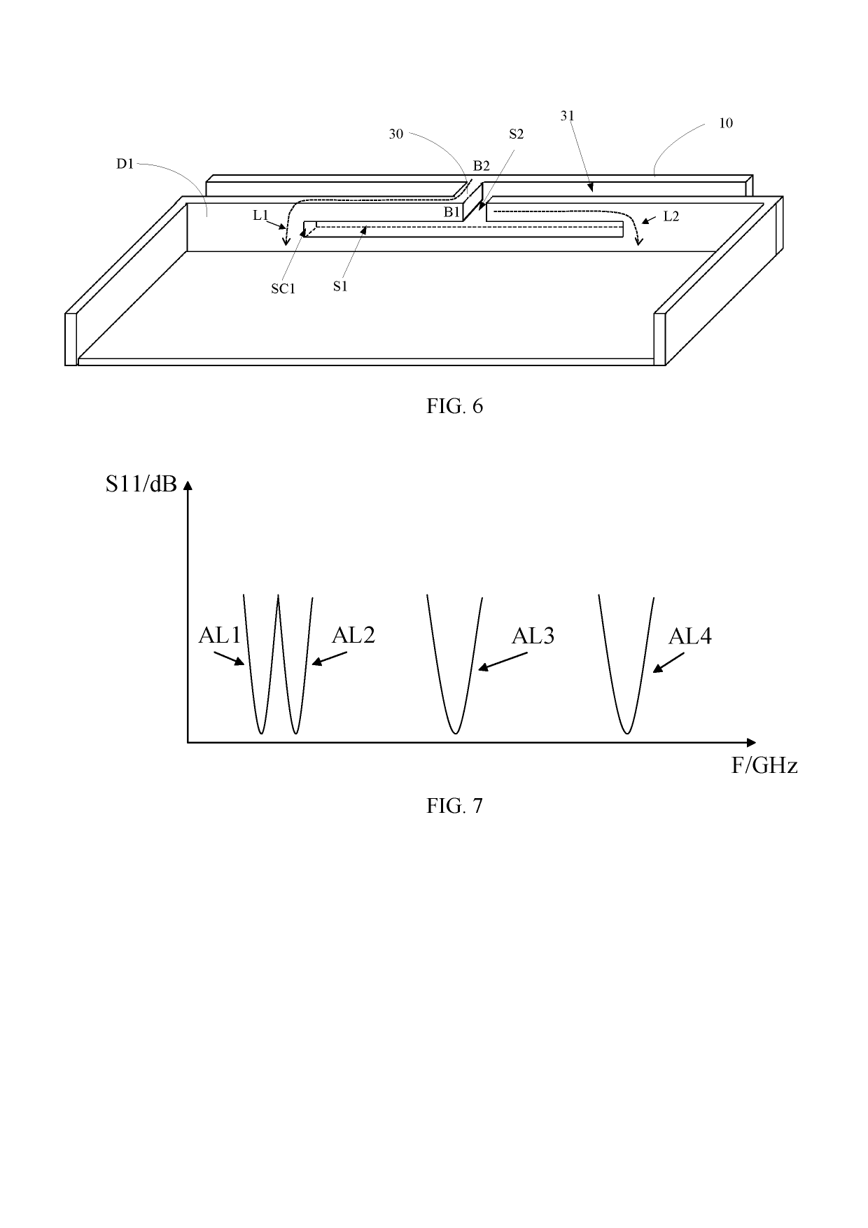

As shown in FIG. 6, in this embodiment of this application, on a basis of Embodiment 1, a first split S2 is further provided on the first sidewall D1, the first split S2 is communicated with the first gap 31 and the first through hole S1, and the first position B1 is located on one side of the first split S2.

In the embodiment shown in FIG. 6, that the first position B1 is located on a left side of the first split S2, that is, on a sidewall of the first split S2 close to the second slit SL1 is used as an example for description. In another implementation, the first position B1 may be located on a right side of the first split S2. This is not specifically limited herein. For ease of description, in this embodiment of this application, that the first position B1 is located on the left side of the first split S2 is used as an example for description and constitutes no specific limitation herein.

In this embodiment, the first gap 31 is communicated with the first through hole S1 via the first split S2. In this case, a grounding path of antenna energy at the second position B2 is as follows: the connecting member 30-->the first position B1-->L1-->G1. A region between a sidewall of the first through hole S1 located on the right side of the first split S2 and the backplane G1 may form a resonance path L2.

In other words, in this implementation, a ground return path L1 and the connecting member 30 are used to form an energy transmission section. The first through hole S1 may generate a high-frequency operating resonance (for example, N41/N78/N79). In addition, a high-frequency operating resonance (for example, N41/N78/N79) may also be generated in the region between the sidewall of the first through hole S1 located on the right side of the first split S2 and the backplane G1, thereby greatly broadening an operating frequency band of the antenna module.

Optionally, a distance between the first position B1 and a first short edge SC1 of the first through hole S1 is less than or equal to a 1/2 wavelength of the first operating frequency band, and the first position B1 and the first short edge SC1 are located on a same side of the first split.

Optionally, in actual engineering, the distance between the first position B1 and the first short edge SC1 of the first through hole S1 may be controlled between 30–60 mm.

In this implementation, by limiting the distance between the first position B1 and the first short edge SC1 of the first through hole S1 to be less than or equal to a 1/2 wavelength of the first operating frequency band, resonance interference generated by a slot between the first position B1 and the first short edge SC1 of the first through hole S1 can be reduced.

As shown in FIG. 3, the operating frequency band of the antenna module in the electronic device provided in Embodiment 1 of this application may include three operating frequency bands, which are respectively AL01, AL02, and AL03. AL01 and AL02 are two low-frequency operating resonators (formed in a combination of the M11 mode, the M12 mode, and the M21 mode of the entire first radiator 10 between the second slit SL1 and the third slit SL2). AL03 is a resonance operating in a medium-high frequency range (corresponding to a half-wavelength slot mode formed by the first through hole S1, which may be N41 or another frequency band).

As shown in FIG. 7, the operating frequency band of the antenna module in the electronic device provided in Embodiment 2 of this application may include four operating frequency bands, which are respectively AL1, AL2, AL3, and AL4. AL1 and AL2 are two low-frequency operating resonators (formed in a combination of the M11 mode, the M12 mode, and the M21 mode of the entire first radiator 10 between the second slit SL1 and the third slit SL2). AL3 is a resonance operating in a medium-high frequency range (corresponding to the half-wavelength slot mode formed by the first through hole S1, which may be N41 or another frequency band). AL4 is a resonator operating in a higher frequency range (corresponding to an IFA 1/4 wavelength mode formed in the region between the sidewall of the first through hole S1 located on the right side of the first split S2 and the backplane G1, which may be N78 or N79 or another frequency band).

It may be learned from FIG. 3 and FIG. 7 that, in Embodiment 2, the operating frequency band of the antenna module in the medium-high frequency band can be increased by adding the first split S2.

### Embodiment 3

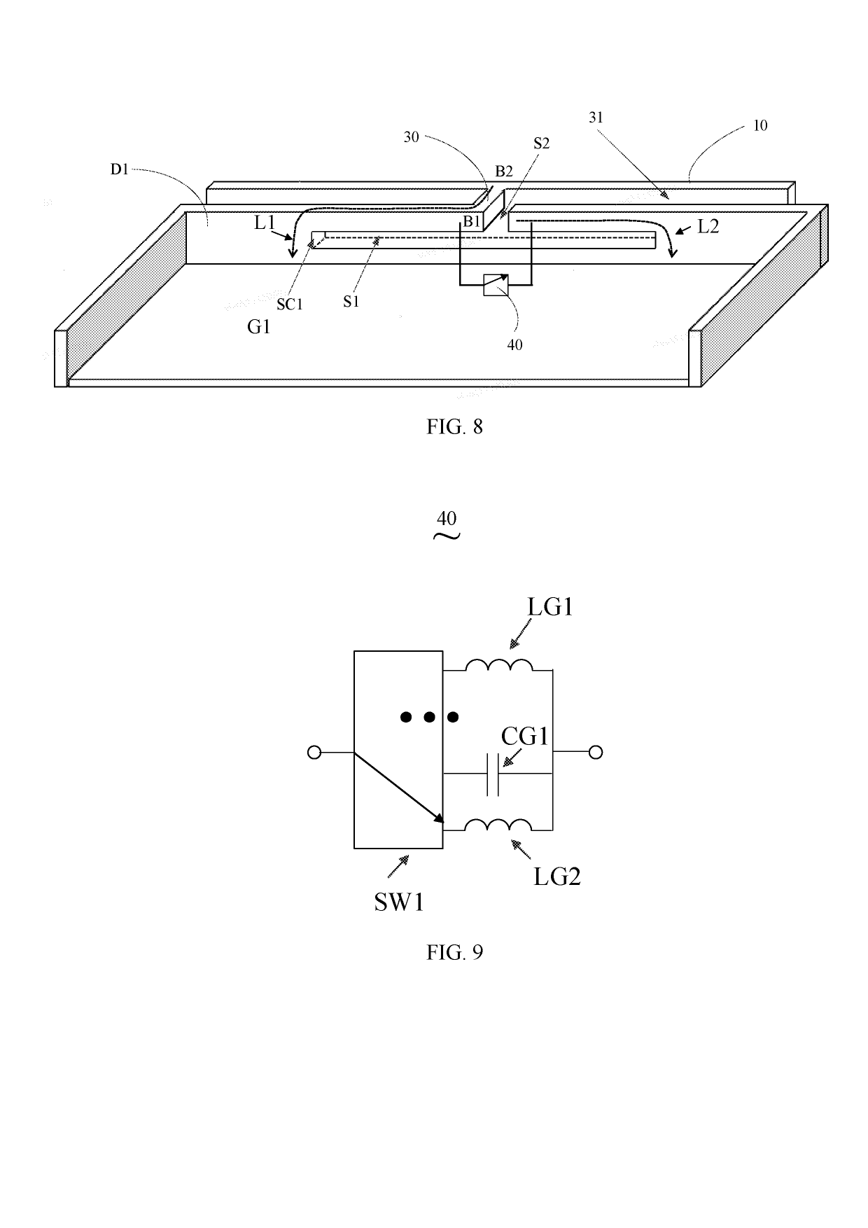

Referring to FIG. 8, in comparison with Embodiment 2, a first switching module 40 is added between two ends of the first split S2 in this embodiment of this application. The first switching module 40 is connected between the two ends of the first split S2, a first parameter of the first switching module 40 is adjustable, and the first parameter includes at least one of a capacitance value, a resistance value, and an inductance value.

Optionally, in some implementations, the first switching module 40 may include at least one of components such as a switching switch, a capacitor, a resistor, and an inductor. At least one of a capacitance value, a resistance value, and an inductance value between two opposite sidewalls of the first split S2 may be adjusted based on the first switching module 40.

For example, as shown in FIG. 9, the first switching module 40 may include a switching switch SW1. One end of the switching switch SW1 is connected to one sidewall of the first split S2, and another end of the switching switch SW1 is separately connected to the other sidewall of the first split S2 via different resistive, capacitive, and inductive components such as a first inductor LG1, a second inductor LG2, and a first capacitor CG1. In this way, at least one of the capacitance value, the resistance value, and the inductance value between the two opposite sidewalls of the first split S2 may be switched via the switching switch SW1.

Optionally, the first switching module 40 may be connected between the two opposite sidewalls of the first split S2 through spot welding on a flexible printed circuit (FPC), or may be connected between the two opposite sidewalls of the first split S2 via an elastic piece which is on a hard board such as a printed circuit board (PCB).

In this implementation, the first switching module 40 may be used to adjust at least one of the capacitance value, the resistance value, and the inductance value between the two opposite sidewalls of the first split S2, so that frequency tuning can be performed on the shifted M12 mode, thereby enabling the antenna module to operate in more frequency bands, and improving antenna performance in a handheld scenario via more low frequency bands.

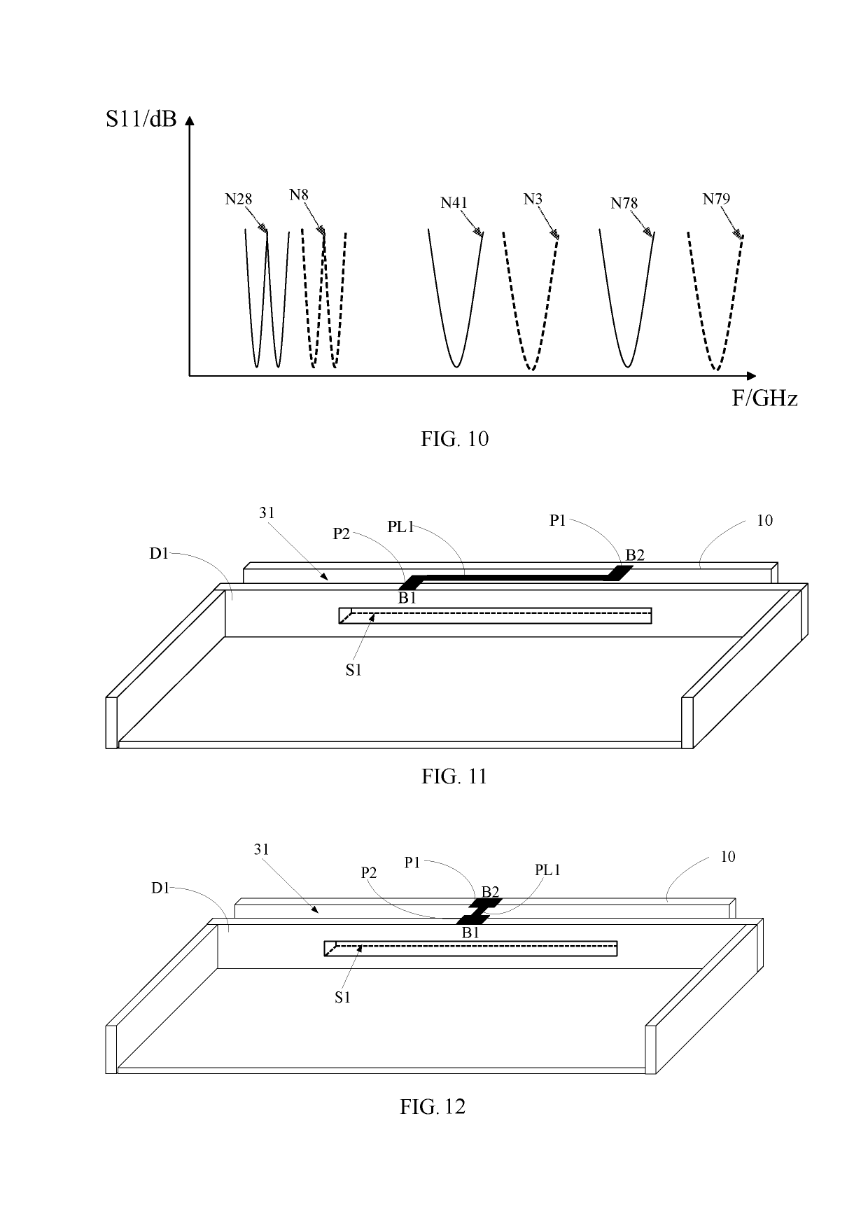

For example, as shown in FIG. 10, at least one of the capacitance value, the resistance value, and the inductance value between the two opposite sidewalls of the first split S2 is adjusted via the first switching module 40, so that the AL1 frequency band and the AL2 frequency band shown in FIG. 7 can be switched from a band N28 to a band N8, and/or the AL3 frequency band shown in FIG. 7 can be switched from the band N41 to a band N3, and/or the AL4 frequency band shown in FIG. 7 can be switched from the band N78 to the band N79 or a Wi-Fi 5G frequency band.

### Embodiment 4

In comparison with Embodiment 1, the connecting member 30 is improved in this embodiment of this application.

As shown in FIG. 11 or FIG. 12, the connecting member 30 includes a first connection portion P2, a second connection portion P1, and a third connection portion PL1.

The first connection portion P2 is connected to the first position B1, the second connection portion P1 is connected to the second position B2, and the third connection portion PL1 is connected between the first connection portion P2 and the second connection portion P1.

In this implementation, the first connection portion P2, the second connection portion P1, and the third connection portion PL1 may be located on a same straight line, or may be located on different straight lines.

For example, as shown in FIG. 11, the third connection portion PL1 is parallel to and spaced apart from the first sidewall D1, and the first connection portion P2 and the second connection portion P1 are respectively located at two ends of the third connection portion PL1. In this case, a grounding structure of a distributed inductor may be formed through a gap between the third connection portion PL1 and the first sidewall D1, so that the first through hole S1 may not be disposed on the first sidewall D1. In comparison with a case in which the first through hole S1 is provided on the first sidewall D1 in Embodiment 1, structural strength of the metal battery compartment 20 can be improved.

For another example, as shown in FIG. 12, the first connection portion P2, the second connection portion P1, and the third connection portion PL1 may be located on the same straight line. In this case, the first through hole S1 may be provided on the first sidewall D1, to form the grounding structure of the distributed inductor.

In an implementation, as shown in FIG. 11 or FIG. 12, the first connection portion P2, the second connection portion P1, and the third connection portion PL1 may form a metal ultrasonic FPC together. In this case, a connection between the first connection portion P2 and the first position B1 and a connection between the second connection portion P1 and the second position B2 may be implemented in a manner of FPC ultrasonic welding.

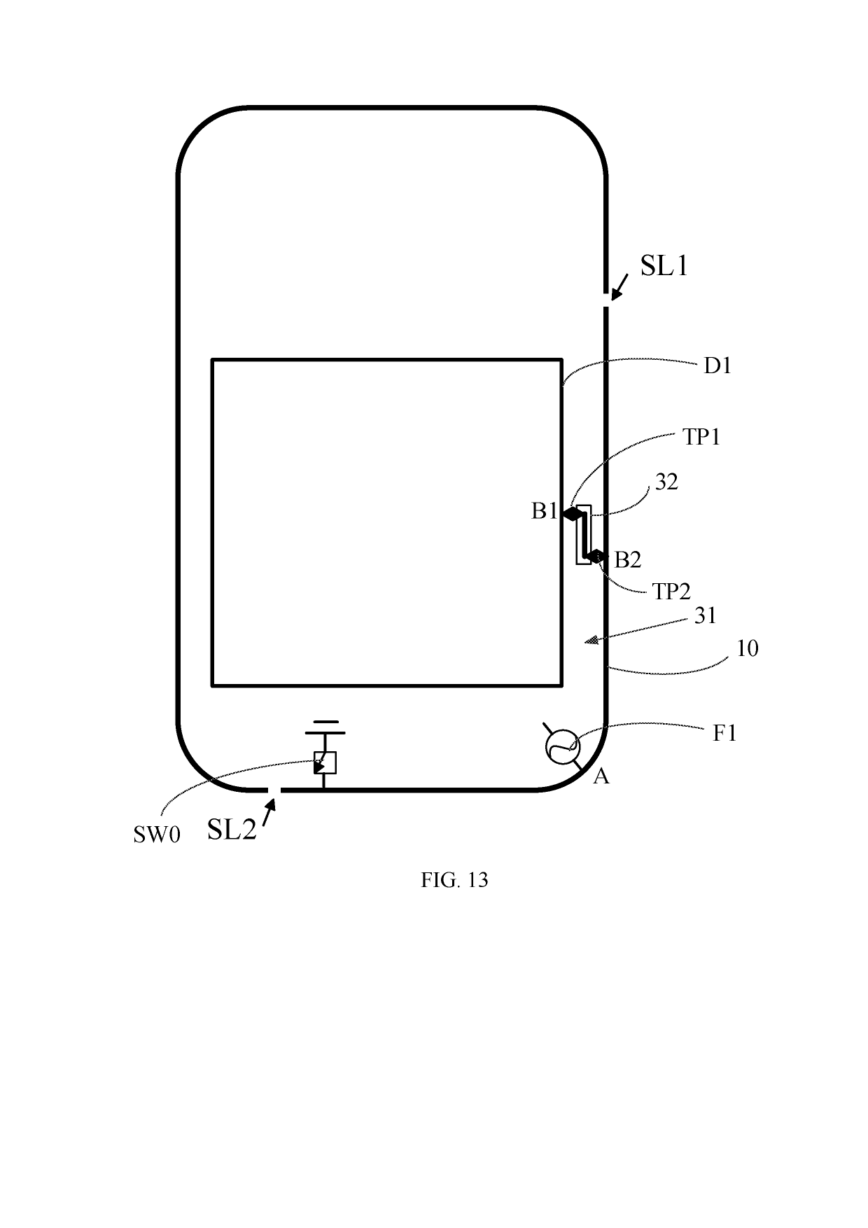

In another implementation, as shown in FIG. 13, a small board 32, for example, a circuit board in a form of a PCB, an FPC, a liquid crystal polymer (LCP), a modified polyimide (modified polyimide, MPI), or the like, may be disposed in the first gap 31. A first elastic piece TP1 and a second elastic piece TP2 may be respectively disposed at two ends of the small board 32. The small board 32 may be horizontally or vertically embedded in plastic in the first gap 31. In this way, one end of the first elastic piece TP1 is fixedly connected to the small board 32, and the other end thereof is pressed against the first position B1. One end of the second elastic piece TP2 is fixedly connected to the small board 32, and the other end thereof is pressed against the second position B2. In addition,on the small board 32, the first elastic piece TP1 may be connected to the second elastic piece TP2 via a metal wire.

In other words, the first elastic piece TP1 serves as the first connection portion, the second elastic piece TP2 serves as the second connection portion, and the metal wire connecting the first elastic piece TP1 to the second elastic piece TP2 serves as the third connection portion.

In this implementation, a connection manner in which the elastic piece is pressed against a corresponding position is used, and in comparison with a connection manner of FPC ultrasonic welding shown in FIG. 11 or FIG. 12, ultrasonic welding does not need to be performed. This reduces assembly complexity and assembly costs of the antenna module. In addition, connection reliability can be improved in comparison with the foregoing welded structure, for example, a weld may be cracked when being subjected to shock.

### Embodiment 5

As shown in FIG. 14, in this embodiment, on a basis of the embodiment shown in FIG. 13, a second switching module Q1 is further connected in series to the metal wire connecting the first elastic piece TP1 to the second elastic piece TP2 on the small board 32.

Optionally, the third connection portion includes:

the second switching module Q1, where the second switching module Q1 is connected in series between the first connection portion and the second connection portion, a second parameter of the second switching module Q1 is adjustable, and the second parameter includes at least one of a capacitance value, a resistance value, and an inductance value.

Optionally, a structure of the second switching module Q1 is similar to a structure of the first switching module 40. For example, the second switching module Q1 may include at least one of components such as a switching switch, a capacitor, a resistor, and an inductor. At least one of a capacitance value, a resistance value, and an inductance value between the first elastic piece TP1 and the second elastic piece TP2 may be adjusted based on the second switching module Q1.

The second switching module Q1 may be connected in series between the first elastic piece TP1 and the second elastic piece TP2 via the metal wire on the small board 32.

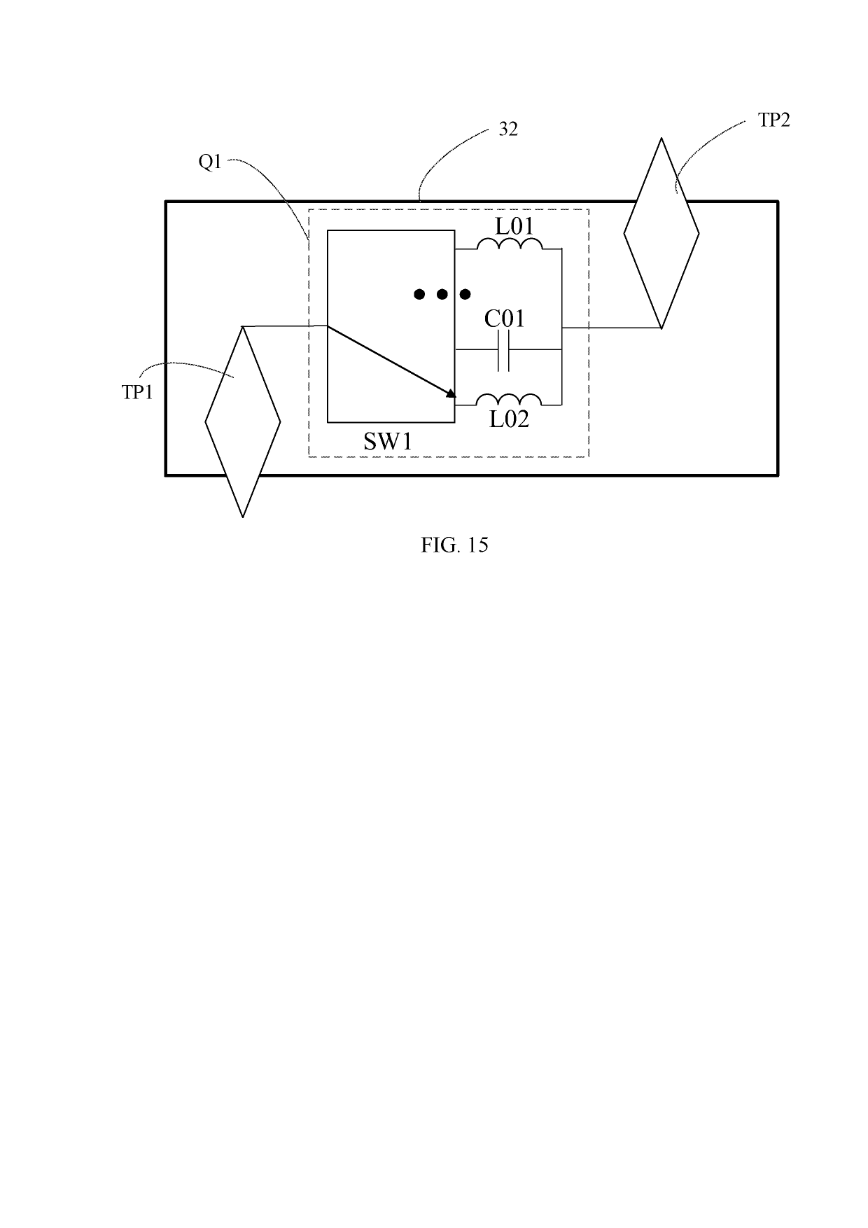

For example, as shown in FIG. 15, the second switching module Q1 may include a switching switch SW2. One end of the switching switch SW2 is connected to the first elastic piece TP1, and another end of the switching switch SW2 is separately connected to the second elastic piece TP2 via different resistive, capacitive, and inductive components such as a third inductor L01, a fourth inductor L02, and a second capacitor C01. In this way, at least one of the capacitance value, the resistance value, and the inductance value between the first elastic piece TP1 and the second elastic piece TP2 may be switched via the switching switch SW2.

Embodiment 5 has same beneficial effects as an elastic piece connection structure shown in FIG. 13. In addition, at least one of the capacitance value, the resistance value, and the inductance value between the first elastic piece TP1 and the second elastic piece TP2 can be adjusted via the second switching module Q1, to implement tuning functions of more operating frequency bands, for example, obtain an effect of adding the operating frequency band of the antenna module shown in FIG. 10.

Optionally, the electronic device provided in the embodiments of this application may be a terminal, or may be another device different from the terminal. The terminal may be a mobile electronic device, or may be a non-mobile electronic device. For example, the mobile electronic device may be a mobile phone, a tablet computer, a notebook computer, a palmtop computer, a vehicle-mounted electronic device, a mobile Internet device (MID), an augmented reality (AR)/virtual reality (VR) device, a robot, a wearable device, an ultra-mobile personal computer (UMPC), a netbook or a personal digital assistant (PDA), or the like. The non-mobile electronic device may be further a server, a network attached storage (NAS), a personal computer (PC), a television (TV), a teller machine, a self-service machine, or the like. This is not specifically limited in this embodiment of this application.

It should be noted that in this specification, the term "include", "comprise", or any of their variants is intended to cover a non-exclusive inclusion, so that a process, method, article, or apparatus that includes a list of elements not only includes those elements but also includes other elements that are not expressly listed, or further includes elements inherent to such a process, method, article, or apparatus. Without more constraints, an element preceded by "includes a …" does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many other manners without departing from principles of this application and the protection scope of the claims, and all such manners fall within the protection scope of this application.

1. An electronic device, comprising a first radiator, a metal battery compartment, and a connecting member, wherein
the first radiator comprises a first end and a second end, and a feed point of the first radiator is located between the first end and the second end;
the metal battery compartment comprises a first sidewall and a backplane, the first sidewall is disposed on a periphery of the backplane, and the backplane is grounded;
the first radiator is located outside the metal battery compartment, and there is a first gap between the first radiator and the first sidewall;
the connecting member is located in the first gap, and is connected to a first position of the first sidewall and a second position of the first radiator; and the second position is located between the first end of the first radiator and the feed point; and
a first through hole is provided on the first sidewall, the first through hole extends in a length direction of the first radiator, and the first through hole is provided between the first position and the backplane; or a distributed inductor is formed between the connecting member and the first sidewall.

2. The electronic device according to claim 1, wherein a length of the first through hole is less than or equal to a 1/2 wavelength of a first operating frequency band of an antenna module corresponding to the first radiator.

3. The electronic device according to claim 1, wherein a length of a region in the first radiator that is located between the feed point and the second position is less than or equal to a 1/2 wavelength of the first operating frequency band, and the first operating frequency band is an operating frequency band of the antenna module corresponding to the first radiator.

4. The electronic device according to claim 1, wherein a first split is further provided on the first sidewall, the first split is communicated with the first gap and the first through hole, and the first position is located on one side of the first split.

5. The electronic device according to claim 4, wherein a distance between the first position and a first short edge of the first through hole is less than or equal to a 1/2 wavelength of the first operating frequency band, and the first position and the first short edge are located on a same side of the first split.

6. The electronic device according to claim 4, further comprising:
a first switching module, wherein the first switching module is connected to two ends of the first split, a first parameter of the first switching module is adjustable, and the first parameter comprises at least one of a capacitance value, a resistance value, or an inductance value.

7. The electronic device according to claim 1, wherein the connecting member comprises a first connection portion, a second connection portion, and a third connection portion; and
the first connection portion is connected to the first position, the second connection portion is connected to the second position, and the third connection portion is connected between the first connection portion and the second connection portion.

8. The electronic device according to claim 7, wherein the third connection portion is disposed parallel to the first sidewall.

9. The electronic device according to claim 7, wherein the third connection portion comprises:
a second switching module, wherein the second switching module is connected in series between the first connection portion and the second connection portion, a second parameter of the second switching module is adjustable, and the second parameter comprises at least one of a capacitance value, a resistance value, or an inductance value.

10. The electronic device according to claim 1, wherein the first end is located on a first long edge of the electronic device, the second end is located on a first short edge of the electronic device, and the first long edge is adjacent to the first short edge.

11. The electronic device according to claim 10, wherein the second position is located in a target region on the first long edge, and the target region is located outside a landscape handheld region of the electronic device.

12. The electronic device according to claim 2, wherein a length of a region in the first radiator that is located between the feed point and the second position is less than or equal to a 1/2 wavelength of the first operating frequency band, and the first operating frequency band is an operating frequency band of the antenna module corresponding to the first radiator.

13. The electronic device according to claim 2, wherein a first split is further provided on the first sidewall, the first split is communicated with the first gap and the first through hole, and the first position is located on one side of the first split.

14. The electronic device according to claim 3, wherein a first split is further provided on the first sidewall, the first split is communicated with the first gap and the first through hole, and the first position is located on one side of the first split.

15. The electronic device according to claim 5, further comprising:
a first switching module, wherein the first switching module is connected to two ends of the first split, a first parameter of the first switching module is adjustable, and the first parameter comprises at least one of a capacitance value, a resistance value, or an inductance value.

16. The electronic device according to claim 2, wherein the connecting member comprises a first connection portion, a second connection portion, and a third connection portion; and
the first connection portion is connected to the first position, the second connection portion is connected to the second position, and the third connection portion is connected between the first connection portion and the second connection portion.

17. The electronic device according to claim 3, wherein the connecting member comprises a first connection portion, a second connection portion, and a third connection portion; and
the first connection portion is connected to the first position, the second connection portion is connected to the second position, and the third connection portion is connected between the first connection portion and the second connection portion.

18. The electronic device according to claim 4, wherein the connecting member comprises a first connection portion, a second connection portion, and a third connection portion; and
the first connection portion is connected to the first position, the second connection portion is connected to the second position, and the third connection portion is connected between the first connection portion and the second connection portion.

19. The electronic device according to claim 5, wherein the connecting member comprises a first connection portion, a second connection portion, and a third connection portion; and
the first connection portion is connected to the first position, the second connection portion is connected to the second position, and the third connection portion is connected between the first connection portion and the second connection portion.

20. The electronic device according to claim 6, wherein the connecting member comprises a first connection portion, a second connection portion, and a third connection portion; and
the first connection portion is connected to the first position, the second connection portion is connected to the second position, and the third connection portion is connected between the first connection portion and the second connection portion.
